(19) United States
(12) Patent Application Publication
(10) Pub. No.: US 2010/0223193 A1
(43) Pub. Date: Sep. 2, 2010

(54) CARD-NOT-PRESENT FRAUD PREVENTION

(75) Inventors: Moshe Weiner, Kiryat Savion (IL); Gil Weil, Shoam (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: WRITEPHONE COMMUNICATION LTD, Or Yehuda (IL)

(21) Appl. No.: 12/161,568

(22) PCT Filed: Jan. 25, 2007
(86) PCT No.: PCT/IL2007/000098

§ 371 Date: Jul. 20, 2008

Related U.S. Application Data
(60) Provisional application No. 60/764,324, filed on Feb. 2, 2006.

(51) Int. Cl. G06Q 99/00; G06Q 40/00; G06Q 10/00; H04W 4/00

(52) U.S. Cl. 705/325; 455/466

(57) ABSTRACT

A system and method for preventing card not present (CNP) fraud by a customer performing a CNP transaction with a transaction provider. The customer signature and at least one added identification input related to the transaction are provided to and stored on a dedicated server. The customer signature and added ID input are then retrieved by the transaction provider in case the customer denies the transaction, to prove that the transaction was valid.

### FIELD OF THE INVENTION

The present invention relates to credit card fraud prevention and in particular to a system and method that can prevent the raising fraud trend known as Card-Not-Present (CNP) fraud.

### BACKGROUND OF THE INVENTION

There are two known major types of fraud in use of and/or in transactions involving credit cards. The first type relates to lost, stolen and counterfeit cards (“illegal” cards). This type of fraud is carried out by someone who is not a legal holder of the credit card used in the transaction. The second type of fraud is related to CNP transactions, specifically when an illegal user uses a “legal” credit card which is not physically present at the point of sale (e.g. for a telephone based and/or Internet based transaction), and when the legal user denies or challenges later the transaction and states that he/she never took part in the transaction and/or never received the goods or the services.

CNP is a well known method of procurement. The procurement may be a telephone-based procurement, an Internet based procurement, etc, in which the credit card is simply physically not present at the selling point. The advent of chip-and-PIN (personal identification number) technology is shifting general credit card fraud further into CNP sales channels. Chip-and-PIN was designed to tackle lost, stolen and counterfeit cards. CNP fraud is done much more simply: the buyers simply deny involvement in the procurement. As they never sign any paper, there is no legal evidence for the transaction and a user who denies the transaction simply gets his/her money back. The standard checks of card number and three-digit security number on the back of the credit cards are simply not enough to prevent CNP fraud. Additional checks need to be introduced, particularly because the number of CNP transactions is certain to increase as more people shop online. While the term CNP refers specifically to credit card transactions, other transactions (for example banking or stock exchange transactions) may involve such fraud. For example, money wiring or stock purchases may be performed and then denied by a customer.

Normally, in a credit card transaction performed in person by a customer at a dealer, the signature is collected physically from the customer. In a remote transaction, the signature collection is problematic. A customer cannot always use a fax device in order to deliver his/her signature to the remote dealer. In case the customer has only a phone device (and no fax), it is impossible to collect his/her signatures.

Signature verification and/or authentication methods, for example by Verisign™, VeriSign Worldwide Headquarters, 487 East Middlefield Road, Mountain View, Calif. 94043, are known and widely used in credit card transactions. However, verification/authentication has disadvantages: it is not always possible to sign and send the signature, for example in transactions done via the telephone. Furthermore, even if the customer is verified and/or authenticated at the time of the transaction, a transaction denial may still occur later, with no legally acceptable evidence left. In CNP fraud, the verification or authentication of the customer does not do any good, as there is no legal proof for the transaction. Also, while prior art suggests a way to collect customer signatures and to have the signatures go through an authentication process, prior art systems lack a storage mechanism to store the signatures.

There is therefore a need for, and it would be advantageous to have a system and method for preventing CNP fraud that does not suffer from the above-mentioned disadvantages.

### SUMMARY OF THE INVENTION

The present invention discloses an innovative system, method and device to prevent certain fraudulent actions related to CNP transactions. The term “CNP” as used for the purposes of the present invention is specifically meant to cover not only credit card transactions but any transaction that can be later denied by a customer (“deniable transaction”) and which can benefit from the system and method disclosed herein. Examples of such transactions include banking transactions, in particular money wiring transfers, and other financial transactions such as share, option and bond purchase orders. A key feature of the invention is the use of stored customer signatures in a central storage facility, the stored signatures to be used as “evidence” in case of transaction denial after a CNP transaction. Such signatures can be collected during the CNP transaction or in a period preceding or following the transaction. The collection can be done in different ways: via a Free Hand short messaging service (SMS) system, as described for example in U.S. Patent Application 20020159600 “Free Hand Mobile Messaging Method and Device” by Moshe Weiner; via a Multimedia Messaging Service (MMS) message that either uses a picture message of the signature (the picture taken by using a camera on a cellular phone or a separate camera connected to a cell-phone); via an MMS message using other items identifying the customer; or via an MMS message that uses a Free Hand messaging device. Another key feature of the invention is the use of a signature together with at least one other identification (ID) item or “input” as proof information that a CNP transaction is legal. To clarify, “proof information” as used herein refers to a signature plus at least one added ID input. The proof information may be sent by the customer to the server within the same message e.g. a SMS message. Exemplary ID inputs include transaction (or purchase) number, transaction (or purchase) date, customer name, customer phone number, customer credit card number, etc. The type of ID input that can be used together with the signature for fraud prevention purposes as disclosed herein may be determined by local law or rules. Note that the present invention does not suggest identification and/or authentication of signatures.

In use, the proof information is delivered to the credit card company (also referred to herein as the “transaction authority”) and stored. The transaction number is delivered to the customer by the selling side or by the credit card company, either when the customer and the dealer discuss the transaction, or via a SMS message that requests a reply with a signature. Such a SMS message can be sent for example to the customer by the credit card company after the dealer has requested such an action. In case the transaction is denied or challenged by the customer, the signature, together with the other stored ID information is retrieved by the credit card company or transaction provider and used to prove that the customer actually carried out the transaction. The present invention also suggests a signature retrieval method and device (a retrieval monitor connected to a storage server, the two together performing retrieval of the proof information from the storage server).

According to the present invention there is provided a method for preventing CNP fraud by a customer performing a CNP transaction comprising the steps of: at a central facility, receiving and storing proof information provided by the customer and, by a transaction authority, retrieving the proof information from the central facility to enforce the CNP transaction.

According to one aspect of the method, the step of receiving and storing proof information includes receiving and storing a signature of the customer and an ID input on a storage server.

According to another aspect of the method, the ID input includes an input selected from the group consisting of a transaction number, a transaction provider name, a transaction provider ID, a transaction date, a transaction place, a customer cellular number, a customer name and a customer credit card number.

According to yet another aspect of the method, the step of retrieving includes providing a retrieval monitor in communication with the storage server and using the retrieval monitor to retrieve the proof information.

According to yet another aspect of the method, the receiving of the customer signature includes collecting the signature via a message selected from the group consisting of a SMS message or a MMS message.

According to yet another aspect of the method, the signature image is acquired with a camera selected from the group consisting of a regular digital camera coupled to a cell-phone and a cell-phone camera.

According to yet another aspect of the method, the step of retrieving the proof information from the central facility to enforce the CNP transaction is preceded by a step of, by the customer, denying the CNP transaction.

According to the present invention there is provided a method for preventing CNP fraud by a customer performing a CNP transaction comprising the steps of: providing a signature of the customer and an added identification (ID) input to a dedicated server, storing the customer signature and the added ID input on the server and, upon denial of the CNP transaction, retrieving the customer signature and the added ID input to prove that the CNP transaction is valid.

According to the present invention there is provided a system for preventing fraud by a customer performing a CNP transaction comprising a storage server operative to store proof information, a customer cellular device used as a source of at least part of the proof information, a cellular network for transmitting information between the cellular device and the server, and a retrieval monitor retrieve the proof information from the server in cases the CNP transaction is denied by the customer.

### BRIEF DESCRIPTION OF THE DRAWINGS

The invention is herein described, by way of example only, with reference to the accompanying drawings, wherein:

FIG. 1 shows schematically a system for CNP fraud prevention according to the present invention;

FIG. 2 shows a general flow chart of the major steps in the method for CNP fraud prevention;

FIG. 3 shows the steps of the method in more detail.

### DESCRIPTION OF THE PREFERRED EMBODIMENTS

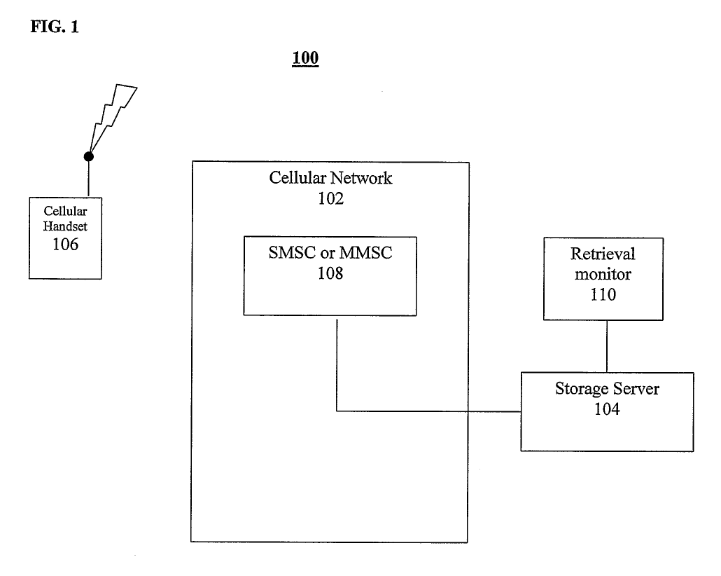

FIG. 1 shows schematically a system 100 for CNP fraud prevention according to the present invention. System 100 comprises a cellular network 102 coupled to a storage server 104 operative to communicate with at least one user having a cellular device (handset) 106 and operative to store customer signatures and other ID inputs received from customers through the network. Network 102 comprises a messaging center 108 that can be exemplarily a Short Messaging Service Center (SMSC) or a Multi Media Messaging Service Center (MMSC). Handset 106 includes a signature input mechanism (not shown), for example a writing pad attached therein as described e.g. in U.S. Patent Application 20020159600, a cellular camera built in the handset, or an optional external camera attached to the handset. In cases in which the signature becomes unidentifiable, e.g. due a focus issues, a dedicated lens may be provided in the camera. A dedicated lens is a small lens or a strip of plastic that can be attached e.g. glued to the camera's lens to provide a readable signature. Such dedicated lenses (or cell-phones with such lenses are manufactured for example by Toda-Seikoh, Japan, Toda Seiko, 1-9-3 Kamitoda, Toda-Shi, Saitama 335-0022, Japan.

The storage server can be located within the premises of the credit card company (or a bank, banking center, financial clearing house, brokerage, etc.) and/or within the premises of the cellular network and\or on the premises of a third party. The server function can be split between two or more of these premises. The connection between the storage server and the cellular network can be either via a Short Message Peer to Peer (SMPP) protocol and/or an IP protocol and/or any other data link. The storage server is connected to a retrieval monitor 110 that allows a credit card company or transaction verifier access to stored proof information that includes customer signatures. The retrieval monitor may either have such details stored within itself (stored and optionally encrypted), or may ask the user to insert such details each time he/she makes a transaction and sends the signature. The retrieval monitor may be configured or programmed to send or ask for information details relevant to the country the transaction is made in and/or relevant to the country of the customer (the two countries not being always the same). The configuration may be done by the dedicated storage server that can have a database for needed information in each country and for cross-country transactions.

In use, the signature is sent to the storage server either by a SMS message or a MMS message via the SMSC or MMSC. The added ID input(s) may be sent the same way or through other channels. ID inputs include the transaction number (e.g. an authorization number issued by the credit card company), the customer's cellular number, the customer's name, the transaction date, the transaction place, the transaction provider's name, the transaction provider's ID or the customer's credit card number. The transaction number can be given to the customer either when he/she makes the phone call for the transaction or by a SMS message that requires him/her to reply. The signature and ID input is stored in the storage server. In case the customer denies he/she ever made the transaction, the credit card company (or in general the “transaction authority”) can search the storage server by using the retrieval monitor. The search may be carried out using any of the ID inputs above.

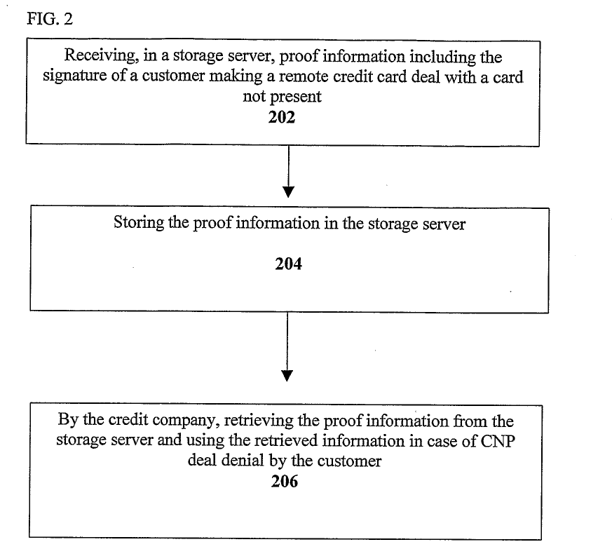

FIG. 2 shows a general flow chart of the major steps in the method for CNP fraud prevention. In step 202, the signature of a customer making a remote CNP credit card transaction (e.g. a telephone or Internet-based transaction) and at least one other ID input are received at the storage server. In step 204, this proof information is stored in the server. In step 206, the proof information is retrieved from the storage and used by the credit card company when issues about the transaction such as denial of original transaction are raised by the customer.

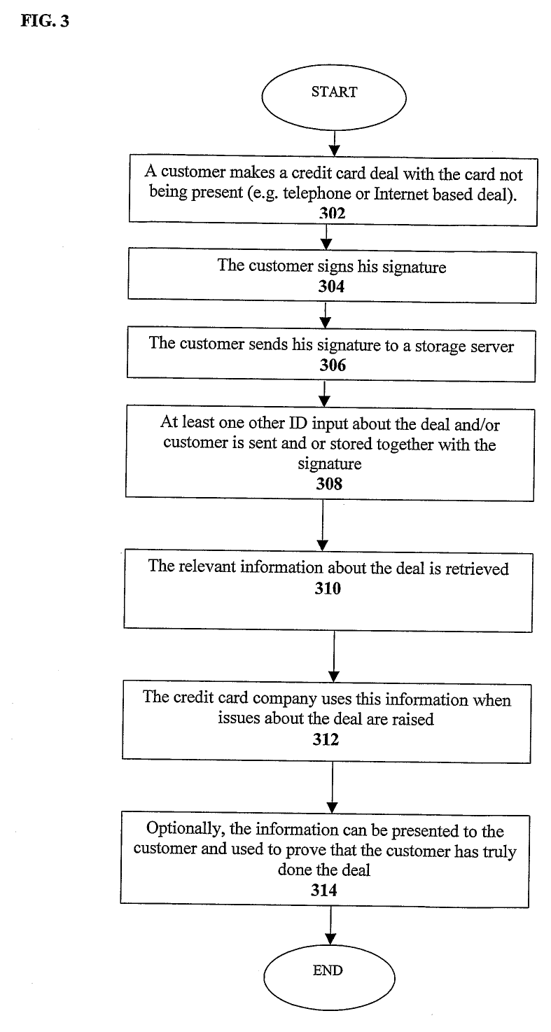

FIG. 3 shows the steps of the method in more detail. The customer makes a CNP credit card transaction in step 302. At this stage and optionally, the customer may get the credit card transaction number from the transaction provider. This can be done by the provider via a phone conversation, by an SMS sent to the customer by the credit company, via e-mail or an instant text message, etc. The customer then signs in step 304. The signing can be done either by signing on a piece of paper and then taking a picture of the signature, by signing on a freehand SMS attachment to the cellular phone (well known in the art), or by using an electronic pen connected to a PC. The customer then sends his signature to the storage server in step 306, using either a SMS message, a MMS message, an email message, an instant text or voice message, voice mail, a push-to-talk session, or any other type of message. At least one other ID input about the deal and/or customer is sent and or stored together with the signature in step 308.

In case the signature is sent via a cell-phone, the present invention further suggests an improvement for the authentication process over prior art, i.e. not only authenticating the signature but also authenticating that the phone sending the signature is valid. Validation of such a phone can be done with help of the cellular companies, which can inform whether such a phone and/or a Subscriber Identity Module (SIM) card were reported as stolen. The signatures may be stored together with the customer's phone number, identification information provided by the SIM card, and other information about the cellular phone, for example a “no report of stolen phone” before the transaction was done. This phone-related information storage will make it hard for customers to deny a certain transaction without them having to report that their cell-phone was stolen before the transaction. Furthermore, if the phone is reported as stolen before the transaction, the transaction will not be approved at all.

The information can be stored on the server for a relevant required time period. For example, the information can be stored for the time period that the credit company deems necessary, e.g. the time period in which the customer can deny the transaction. If needed, the credit card company retrieves the information about the transaction is retrieved in step 310. The credit card company can then use this information when issues about the transaction are raised in step 312. Optionally, the information can be presented to the customer and used to prove that the customer has truly done the transaction in step 314.

The present invention may be used when a transaction is done via a World Wide Web network such as the Internet instead of a cellular network or a telephony (e.g. fax with the signature) network. When using the Internet, the cellular handset can be replaced by a personal computer (PC) or a smart phone such as a Palm device and the connectivity to the storage server can be done directly via the Internet, or by a combination of a wireless service and Internet (e.g. first by WiFi and, then by the Internet). WiFi is a set of product compatibility standards for wireless local area networks (WEAN) based on the WEE 802.11 specifications. New standards beyond the 802.11 specifications, such as 802.16(WiMAX), are currently in the works and offer many enhancements, anywhere from longer range to greater transfer speeds.

All publications and patents mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

What is claimed is:

1. A method for preventing card not present (CNP) fraud by a customer performing a CNP transaction, comprising the steps of:
a. at a central facility, receiving and storing proof information provided by the customer; and
b. by a transaction authority, retrieving the proof information from the central facility to enforce the CNP transaction.

2. The method of claim 1, wherein the step of receiving and storing proof information includes receiving and storing a signature of the customer and an ID input at a storage server.

3. The method of claim 2, wherein the ID input includes an input selected from the group consisting of a transaction number, a transaction provider name, a transaction provider ID, a transaction date, a transaction place, a customer cellular number, a customer name and a customer credit card number.

4. The method of claim 2, wherein the step of retrieving includes providing a retrieval monitor in communication with the storage server and using the retrieval monitor to retrieve the proof information.

5. The method of claim 2, wherein the receiving of the customer signature includes collecting the signature via a message selected from the group consisting of a short messaging service (SMS) message or a multimedia messaging service (MMS) message.

6. The method of claim 5, wherein the MMS message includes a signature image relayed by wireless communications.

7. The method of claim 6, wherein the signature image is acquired with a camera selected from the group consisting of a regular digital camera coupled to a cell-phone and a cell-phone camera.

8. The method of claim 1, wherein the step of retrieving the proof information from the central facility to enforce the CNP transaction is preceded by a step of, by the customer, denying the CNP transaction.

9. A method for preventing card not present (CNP) fraud by a customer performing a CNP transaction comprising the steps of:
a. providing a signature of the customer and an added identification (ID) input to a dedicated server;
b. storing the customer signature and the added ID input on the server; and
c. upon denial of the CNP transaction, retrieving the customer signature and the added ID input to prove that the CNP transaction is valid.

10. The method of claim 9, wherein the step of providing a signature of the customer includes providing the signature using a transmission mode selected from the group consisting of wired transmission and wireless transmission.

11. The method of claim 10, wherein the step of providing the signature of the customer further includes obtaining the customer signature using a camera.

12. The method of claim 9, wherein the step of providing an added ID input includes providing an input selected from the group consisting of a transaction number, a transaction provider name, a transaction provider ID, a transaction date, a transaction place, a customer cellular number, a customer name and a customer credit card number.

13. The method of claim 9, further including the step of providing an added authentication input and storing the added authentication input on the server.

14. The method of claim 13, wherein the authentication input includes subscriber identity module information related to the customer cell-phone.

15. A system for preventing card not present (CNP) fraud by a customer performing a CNP transaction comprising:
a. a storage server operative to store proof information;
b. a customer cellular device used as a source of at least part of the proof information;
c. a cellular network for transmitting information between the cellular device and the server; and
d. a retrieval monitor retrieve the proof information from the server in cases the CNP transaction is denied by the customer.

16. The system of claim 15, wherein the cellular network includes a messaging center for providing messaging services.

17. The system of claim 16, wherein the messaging center is selected from the group consisting of a short messaging service center and a multi media messaging service center.
